(19) United States
(12) Patent Application Publication
(10) Pub. No.: US 2017/0193376 A1
(43) Pub. Date: Jul. 6, 2017

(54) AREA/ENERGY COMPLEX REGULAR EXPRESSION PATTERN MATCHING HARDWARE FILTER BASED ON TRUNCATED DETERMINISTIC FINITE AUTOMATA (DFA)

(71) Applicants: Amit Agarwal, Hillsboro, OR (US); Steven K. Hsu, Lake Oswego, OR (US); Ram K. Krishnamurthy, Portland, OR (US); Bharan Giridhar, Santa Clara, CA (US)

(72) Inventors: Amit Agarwal, Hillsboro, OR (US); Steven K. Hsu, Lake Oswego, OR (US); Ram K. Krishnamurthy, Portland, OR (US); Bharan Giridhar, Santa Clara, CA (US)

(21) Appl. No.: 14/989,694

(22) Filed: Jan. 6, 2016

(51) Int. Cl. G06N 5/04; G06N 7/00

(52) U.S. Cl. CPC G06N 5/047; G06N 7/005

(57) ABSTRACT

A method and apparatus are described for performing complex regex pattern matching utilizing filters based on truncated Deterministic Finite Automata (DFA). For example, one embodiment of a method comprises: representing a set of reference strings as a DFA; truncating the DFA based on a truncating policy, wherein the truncated DFA does not generate a false positive match; creating a filter based on the truncated DFA; filtering an input string against the set of reference strings by running the input string through the filter.

### BACKGROUND

Field of the Invention

This invention relates generally to the field of data processing systems. More particularly, the invention relates to a method and apparatus for performing complex regular expression pattern matching utilizing a hardware filter based on truncated deterministic finite automata.

Description of Related Art

The ability to spot existing or emerging patterns is one of the most critical skills in intelligent decision making. Such skill is more vital in today's technology than ever before. Pattern matching constitutes one of the most power and performance critical operations in applications such as antivirus scanner (AVS), database search, information extraction, and network intrusion detection (NIDS). The increase in network intrusions, virus attacks, and data analysis requirements have prompted a need for matching large numbers of complex and sophisticated patterns with high throughput and accuracy. One solution to address this problem is to represent patterns as complex regular expression (regex) based strings. The expressiveness, flexibility and compactness of regex patterns provide additional syntactic context to further sharpen textual searches. However, performing regex pattern matching in a general purpose microprocessors is computationally intensive and requires significant memory and CPU cycles. For example, regex based virus signatures in ClamAV (an open-source antivirus application) constitute only 2% of the total virus database and yet consume over 71% of the total search time. Although many pattern matching hardware have been proposed in the past, they are, however, typically limited to implementations of simple fixed string with basic regex patterns or exact match hardware that require significant Si area and processing complexity. A dedicated energy efficient hardware filter can offload these types of resource-intensive computation from the general purpose microprocessor while providing the desired high throughput.

### BRIEF DESCRIPTION OF THE DRAWINGS

A better understanding of the present invention can be obtained from the following detailed description in conjunction with the following drawings, in which:

FIG. 1A illustrates an exemplary deterministic finite automaton (DFA);

FIG. 1B illustrates an exemplary DFA truncated at a fixed depth;

FIG. 1C is a chart showing the probability of each DFA state being accessed by benchmark strings in a simulation;

FIG. 2 is a block diagram illustrating a pattern-matching system according to an embodiment;

FIGS. 3A-3C illustrate exemplary ways to truncate a DFA according to various embodiments;

FIG. 4 illustrates an exemplary complex DFA;

FIG. 5 illustrates a high-level hardware system that utilizes hardware accelerators according to an embodiment;

FIG. 6 is a flow diagram illustrating the operation and logic of performing pattern-matching through hardware accelerators according to an embodiment;

FIG. 7 shows an exemplary hardware architecture of the partial pattern matching module according to an embodiment;

FIG. 8 illustrates an exemplary implementation of the state address register file (STA) according to an embodiment;

FIG. 9 illustrates an exemplary implementation of the state-transition register file (STTR) according to an embodiment;

FIG. 10 illustrates an exemplary circuit implementation of a range comparator according to an embodiment;

FIG. 11 is a flow diagram illustrating the operation and logic of the partial pattern matcher in accordance to an embodiment.

FIG. 12A is a block diagram illustrating both an exemplary in-order pipeline and an exemplary register renaming, out-of-order issue/execution pipeline according to embodiments of the invention;

FIG. 12B is a block diagram illustrating both an exemplary embodiment of an in-order architecture core and an exemplary register renaming, out-of-order issue/execution architecture core to be included in a processor according to embodiments of the invention;

FIG. 13 is a block diagram of a single core processor and a multicore processor with integrated memory controller and graphics according to embodiments of the invention;

FIG. 14 illustrates a block diagram of a system in accordance with one embodiment of the present invention;

FIG. 15 illustrates a block diagram of a second system in accordance with an embodiment of the present invention;

FIG. 16 illustrates a block diagram of a third system in accordance with an embodiment of the present invention;

FIG. 17 illustrates a block diagram of a system on a chip (SoC) in accordance with an embodiment of the present invention;

FIG. 18 illustrates a block diagram contrasting the use of a software instruction converter to convert binary instructions in a source instruction set to binary instructions in a target instruction set according to embodiments of the invention;

### DETAILED DESCRIPTION OF PREFERRED EMBODIMENTS

Described below are embodiments of apparatus and method for performing complex regex pattern matching utilizing a hardware filter based on truncated Deterministic Finite Automata (“DFA”). Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are not shown or are shown in a block diagram form to avoid obscuring the underlying principles of the present invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

A deterministic finite automaton (“DFA”)—also known as deterministic finite state machine—is a finite state machine that accepts/rejects finite strings of symbols and only produce a unique computation (or run) of the automaton for each input string. “Deterministic” refers to the uniqueness of the computation. Although a DFA is defined as an abstract mathematical concept, due to the deterministic nature of a DFA, it is implementable in hardware and software for solving various specific problems, including complex regular expression (“regex”) pattern matching.

As mentioned above, complex patterns may be represented as complex regex based strings. These regex based strings, in turn, may be represented as DFAs with O(1) processing complexity and O(2^{m}) storage complexity, where m is the number of characters in the regex string. Moreover, k number of regex patterns can be merged into a single DFA with a maximum storage requirement of O(2^{mk}). Implementing a full DFA in hardware for exact pattern match is very costly in terms of memory storage and processor cycle. The present invention solves this problem by taking into account various unique characteristics of the DFA to generate a hardware filter that is both area and power efficient.

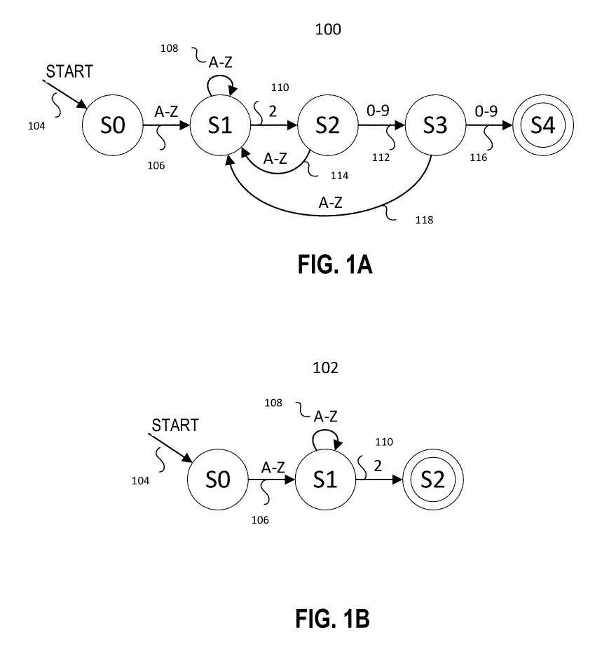

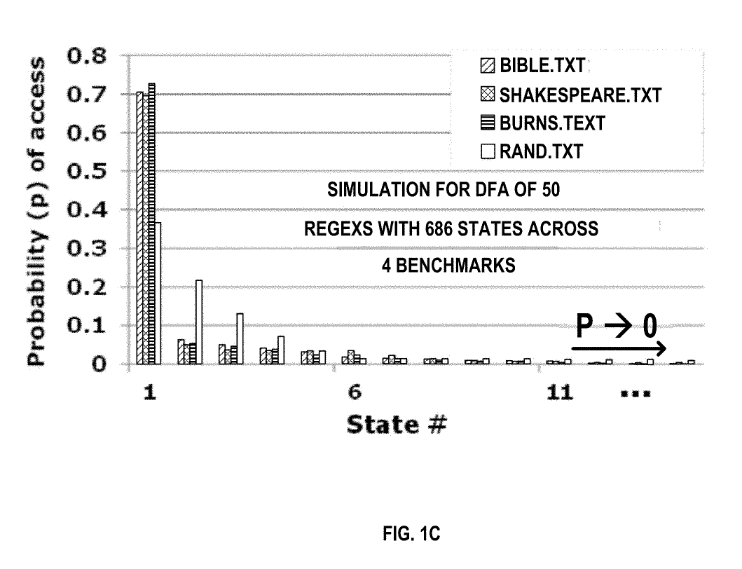

FIG. 1A illustrates an exemplary DFA 100 as a state diagram that comprises of 5 states (S0-S4). The initial state (S0) where the computation begins is denoted graphically by an arrow 104 with the label “Start”. An acceptable state (S4) is denoted by a double circle. For each state, there are one or more transition arrows leading out to a next state. The DFA 100 takes a finite regex string as input. Through processing each character in the finite regex string, the DFA 100 jumps deterministically from a current state to a next state by following a matching transition arrow. The next state may either be the same state as the current state or a different state. However, if no transition arrow at the current DFA state matches the input character being processed, the DFA is returned to the starting state. After a character is processed and the DFA moved to the next state, the next character in the input string is processed to determine the next state, if any, to jump to. This process is repeated until 1) the DFA reaches an acceptable state, indicating a successful match, or 2) there are no more characters left in the string, resulting in an unsuccessful match for the input string.

To illustrate, input string “ABC123” is passed through DFA 100. Starting from state S0, a transition arrow 106 labeled “A-Z” points from S0 to S1. This means that upon reading any uppercase alphabet, DFA 100 would jump deterministically from state S0 to state S1. Conversely, if the character read is not an uppercase alphabet (i.e., lowercase alphabet, number, or symbol), then it would not be a match for transition arrow 106 and the DFA 100 would remain in state S0. With respect to input string “ABC123”, since the first character “A” is an uppercase alphabet, DFA 100 follows the transition arrow 106 and deterministically jumps from state S0 to state S1. Next, from state S1, DFA 100 processes the second character, “B”, from input string “ABC123”. The only transition arrow at state S1 that matches the input character “B” is arrow 108 labeled “A-Z” that loops from S1 back to S1. This means the next state is same as the current state and DFA 100 remains in state S1. From there, DFA 100 reads from the input string the third character, “C”, which again matches the transition arrow 108 that loops from S1 back to S1. The fourth character, “1”, does not match any transition arrow going out of state S1 and therefore, DFA 100 returns to the starting state S0. The fifth and sixth characters of the input string, “2” and “3” respectively, are not alphabets and therefore do not match any transition arrow going out of state S0. As such, DFA 100 remains in state S0. At this point, there are no more characters left in the input string and DFA 100 has yet to reach an acceptable state (e.g., state S4). This means input string “ABC123” is not a match for DFA 100.

To illustrate reaching an acceptable state, string “XYZ246” is passed through DFA 100. From starting state S0, the first character in the input string, “X”, is an uppercase alphabet matching transition arrow 106. Accordingly, DFA 100 jumps from state S0 to state S1 through the transition arrow 106. The second character, “Y”, matches the transition arrow 108 at state S1 which loops from state S1 back to S1 again. The same goes for the third character, “Z” and thus DFA 100 remains in state S1. The fourth character, “2”, matches transition arrow 110 and thus DFA 100 jumps from state S1 to S2. The fifth character, “4”, is a number between 0 and 9 and thus matches transition arrow 112 between states S2 and S3. Accordingly, DFA 100 jumps from S2 to S3. The sixth and final character, “6”, matches the transition arrow 116 leading from state S3 to S4 because 6 is a number between 0 and 9. Following transition arrow 116, DFA 100 arrives at state S4, which is an acceptable state denoted the double circle. By reaching an acceptable state in DFA 100, input string “XYZ246” is deemed a successful match.

In most cases, accesses to a DFA typically do not extend beyond the first few states. In the two examples illustrated above, the sequence of states in DFA 100 accessed by input string “ABC123” was S0→S1→S1→S1→S0→S0→S0. Thus input string “ABC123” did not access any state beyond the first two states. As for input string “XYZ246”, the sequence of states accessed was S0→S1→S1→S1→S2→S3→S4. Thus, while states S2-S4 were eventually accessed by input string “XYZ246”, states S0 and S1 represent the majority of all the states accessed in DFA 100. Various simulations confirm this notion. FIG. 1C is a chart showing the probability of each state in a DFA being accessed by benchmark strings. The DFA used in the simulation is formed by combining 50 regex strings and comprises 686 states. As the chart indicates, most accesses do not extend beyond the first few states. Thus, by taking advantage of this characteristic, a relatively low area-intensive hardware filter can be created by implementing only a portion of the full DFA.

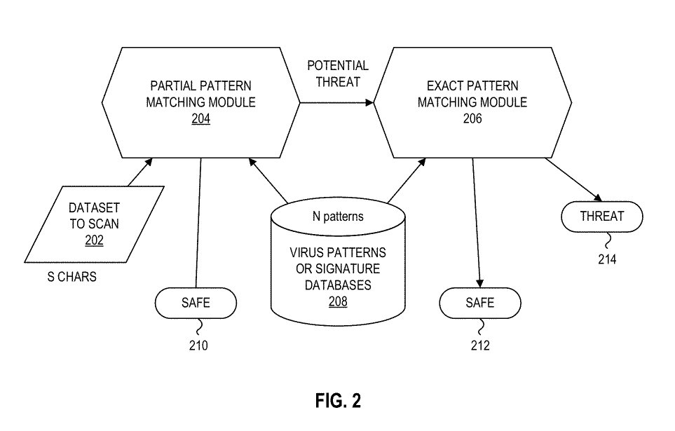

FIG. 2 is a flow diagram of the hardware filter in operation according to an embodiment. The dataset to scan 202 contains strings, such as “ABC123” and “XYZ246” from the examples above, that are to be matched against a set of reference regex strings. The reference regex strings may, for example, be derived from known virus patterns or signature databases 208. The individual reference regex strings are combined together to create a reference DFA. A truncated version of the reference DFA is used to implement a Partial Pattern Matching Module 204. Each string in the dataset to scan 202 is passed through the Partial Pattern Matching Module 204 for initial filtering. An example of a truncated DFA is shown in FIG. 1B, DFA 102 is obtained by truncating the DFA 100 from FIG. 1A. By implementing only a truncated version of the reference DFA rather than a complete one, the Partial Pattern Matching Module 204 uses less memory and processor resources while still able to perform meaningful filtering function. This is because in general, most mismatched regex strings do not reach beyond the first few states of a reference DFA. For example, the Partial Pattern Matching Module 204 would have correctly filtered out the input string “ABC123” despite only implementing the first 3 states (S0-S2) of the reference DFA 100. As seen above, input string “ABC123” does not access any state beyond S0 and S1. As for string “XYZ246”, the Partial Pattern Matching Module 204 only has to process the first four characters, “XYZ2”, before the input string reaching an acceptable state in DFA 102, indicating a potential match.

Strings that are matched in the Partial Pattern Match Module 204 and identified as potential threats are then passed through the Exact Pattern Matching Module 206. Exact Pattern Matching Module 206 can be implemented in hardware, software, or a combination both. Since the search space has been filtered by the Partial Pattern Matching Module 204, the number of strings to pass through Exact Pattern Matching Module 206 is greatly reduced. This minimizes the work needed to be done by the resource-intensive Exact Pattern Matching Module 206.

According to one embodiment, the partial pattern matching module 204 utilizes a filter based on truncating DFAs at a fixed depth. For example, DFA 102, shown in FIG. 1B, is simply DFA 100 truncated at depth 2. Thus, instead of S4, state S2 becomes the new acceptable state in the truncated DFA. The DFA is truncated in a way to create a filter that never generates a false negative match (i.e. generating no match for a scanned dataset when there is actually a match). It is okay, however, for the chosen filter to report false positive matches (i.e. generating a match for a scanned dataset while there is no match).

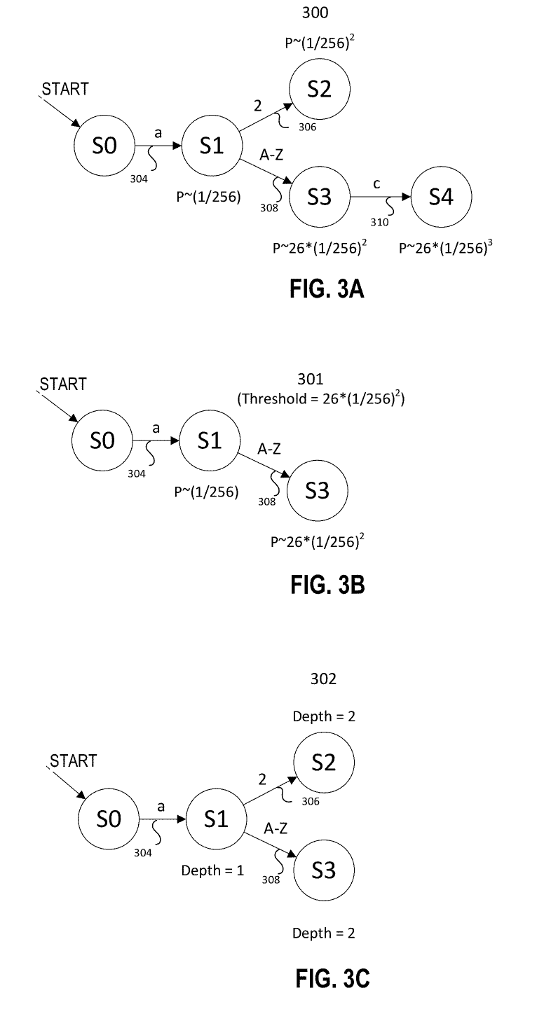

In another embodiment, the partial pattern matching module 204 utilizes a filter created by probability-based truncating. The probability referred to here is the probability for reaching each state in a DFA. Referring to FIG. 3A, DFA 300 comprises 5 states (S0-S4) and the probability of reaching any given state from S0 is listed next to each state. For instance, to reach S1 from S0, the character read from the input string must be a lowercase “a”. If the character read is anything other than “a”, the DFA would remain at S0. In an 8-bit ASCII scheme, the character from the input string could be any one of 2⁸ (i.e. 256) possible encoded characters in the scheme. Thus, the chance of the character read from the input string being an “a” is 1 out of 256. Accordingly, the probability of reaching S1 from S0 is 1/256, as denoted by “P˜(1/256)” under S1.

From S1, there are two possible next states—S2 and S3. To get from S1 to S2, the character “2” is required from the input string. Again, in an 8-bit ASCII scheme, the chance for a given character read from the input string being the number “2” is 1 out of 256, or 1/256. Together, the total probability of reaching S2 from S0 is the product of the probability of reaching S1 from S0 (i.e. 1/256) and the probability of reaching S2 from S1 (i.e. 1/256). As such, the probability of reaching S2 from S0 is (1/256)², as denoted by P˜(1/256)² above S2.

On the other hand, to get to S3 from S1, an uppercase alphabet is required from the input string. In an 8-bit ASCII scheme, the probability for a character being 1 of 26 uppercase alphabets is 26/256 (i.e., 1/256 for each alphabet multiplied by 26 alphabets). Putting it all together, the probability of reaching S3 to S0 is (1/256)*(26/256), or simply 26*(1/256)² as denoted by P˜26*(1/256)² under S3.

Next, to reach S4 from S3, a lowercase character “c” is required from the input string. Using similar logic and calculation as before, the probability for DFA 300 reaching S4 from S3 is 1 out of 256 or 1/256. The total probability of reaching S4 from S0 is the product of the probabilities of going from S0 to S1, S1 to S3, and S3 to S4, which is (1/256)*(26/256)*(1/256), or simply 26*(1/256)³ as denoted by P˜26*(1/256)³

To truncate a DFA based on probability, a threshold probability is first selected and then any state that has a probability lower than the threshold probability is removed from the DFA. The result is a truncated version of the original DFA. For instance, in FIG. 3A, if the threshold probability selected is 26*(1/256)², any state in DFA 300 that has a lower probability than the selected threshold probability is removed from the DFA. For DFA 300, the probabilities of reaching states S1, S2, S3, and S4 from S0 are 1/256, (1/256)², 26*(1/256)², and 26*(1/256)³, respectively. Out of these, the probabilities of reaching S2 and S4 from s0 are both lower than the selected threshold. As such, states S2 and S4 are removed from DFA 300. In contrast, S1 and S3 are not removed because the probability of reaching each of these states from S0 is equal or higher than the selected threshold. FIG. 3B shows the resulting DFA 301 that is obtained by truncating DFA 300 from 3A and using 26*(1/256)² as the threshold probability. In contrast, the same DFA 300 truncated at a fixed depth of 2 is shown in FIG. 3C.

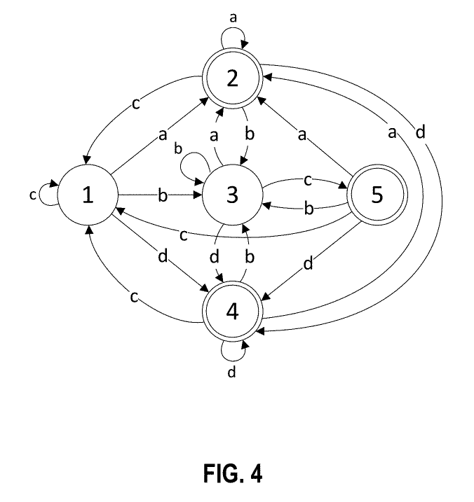

Besides truncating the reference DFA, the footprint of a DFA-based filter may further be optimized by removing redundancy. Since a matching pattern can start from any character in a string, a new check is performed on each character of the input string. This means every character is run through the DFA at least once beginning at S0 to see if it starts a possible match. Due to this continuous prefix evaluation for checking the start of a match, all transitions leading to a particular state tend to check for the same character or character class/range. This property is especially true for early states, such as those in a truncated DFA. For example, in FIG. 4, all transition leading to state 3 is “b”. Thus, by taking into the duplicative nature of early transitions in a DFA, the footprint of a DFA may be further optimized by only storing transitions that are unique.

Moreover, to reduce memory size required for storing the truncated DFA, a more efficient way of representing DFA is adopted. In one embodiment, the DFA is broken down and stored as state-transition (ST) pairs. According to the embodiment, a truncated DFA filter is implemented by storing the transition value and the next state address of every transition originating from a state in a single row of a memory.

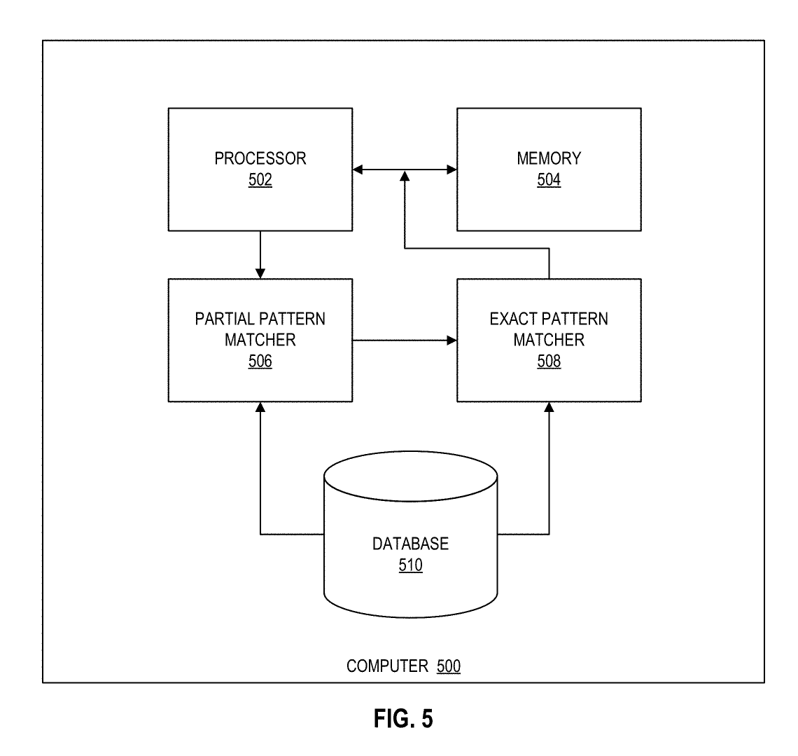

FIG. 5 illustrates a high-level hardware system that utilizes hardware accelerators to perform resource-intensive pattern-matching tasks according to an embodiment. The hardware system includes a processor 502, a memory 504, a partial pattern matcher 506, an exact pattern matcher 508, and a database 510. Each hardware component in the system is coupled by a high-speed interconnect. The processor 502 offloads tasks that require matching patterns to the partial pattern matcher 506 which performs the initial filtering. Any potential matches are then inputted into the exact pattern matcher 508 for further verification. The results of the match are then returned to the processor 502 or stored into memory 504.

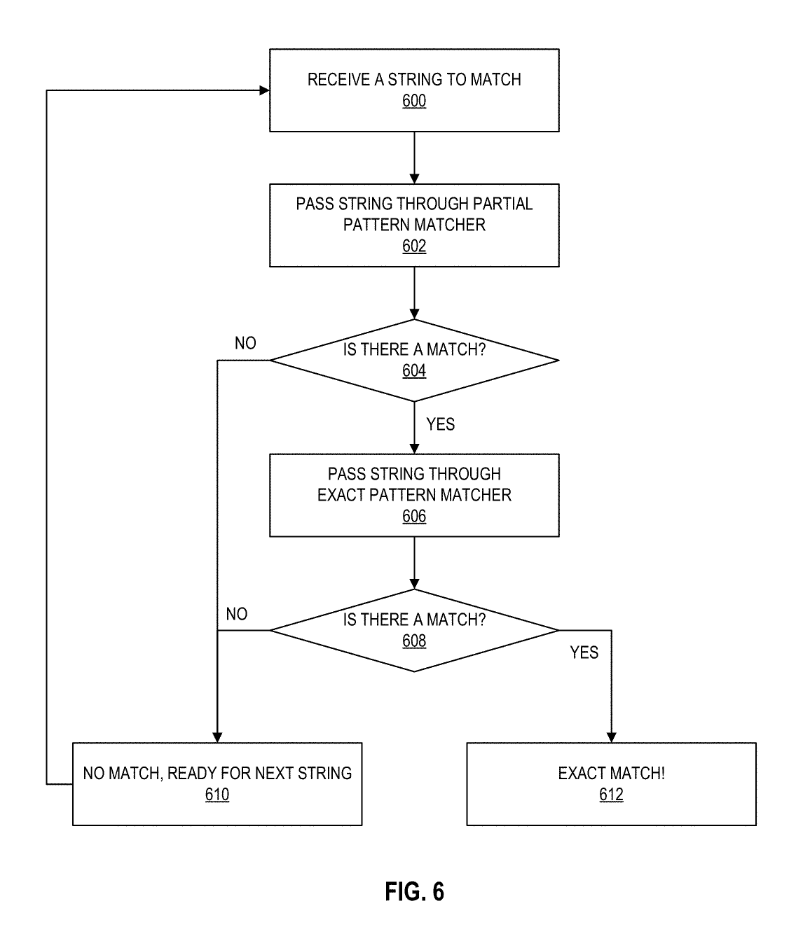

FIG. 6 is a flow diagram illustrating the operation and logic of performing pattern-matching through hardware accelerators. At block 600, a processor receives an input string to be matched against a set of reference strings. In block 602, the input string is passed through the partial pattern matcher. In block 604, the partial pattern matcher performs the initial filtering. If the input string does not draw a match in the partial pattern matcher, it is not a match and the process starts over with a new string in block 610. If in block 604 the input string draws a match in the partial pattern matcher, it is then passed to the exact pattern matcher in block 606 for further verification. In block 608, the exact pattern matcher performs the resource-intensive exact pattern matching. If the input string does not draw an exact match, the process starts over with a new string in block 610. However, if an exact match is found, the results are returned to the processor in block 612.

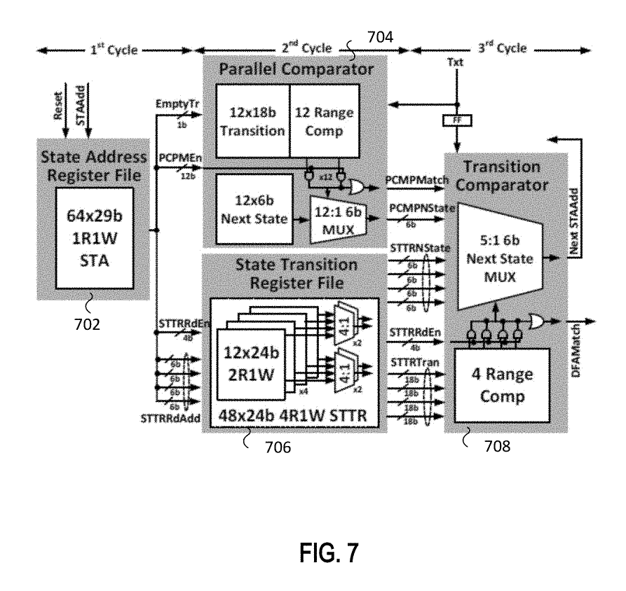

FIG. 7 shows an exemplary hardware architecture of the partial pattern matching module according to one embodiment. The partial pattern matching module includes a 64-entry×29 b 1R/1W state address register file (STA) 702, a 48-entry×24 b 4R/1W state-transition register file (STTR) 706, a 12-entry×24 b register file with 12 parallel range comparators (PCMP) 704, and a transition comparator with 4 parallel range comparator (TCMP) 708. The partial pattern matching module stores in the STA 702 pointers to state-transition pairs for each of the DFA states. The STTR 706 stores all of the unique state-transition pairs in the DFA and out of those, the 12 most common state-transition pairs are stored in PCMP 704. In one embodiment, the STA and STTR comprise memory such as flash memory. The filter operates with a 3-cycle latency and a single cycle throughput for 3 parallel threads. Although certain implementation details, such as quantity and size of the register file, are specified above, one skilled in the arts would appreciate that various other implementations may be used to provide the functionalities described herein. The present invention is not dependent on any specific implementation detail of the comparator and/or register file.

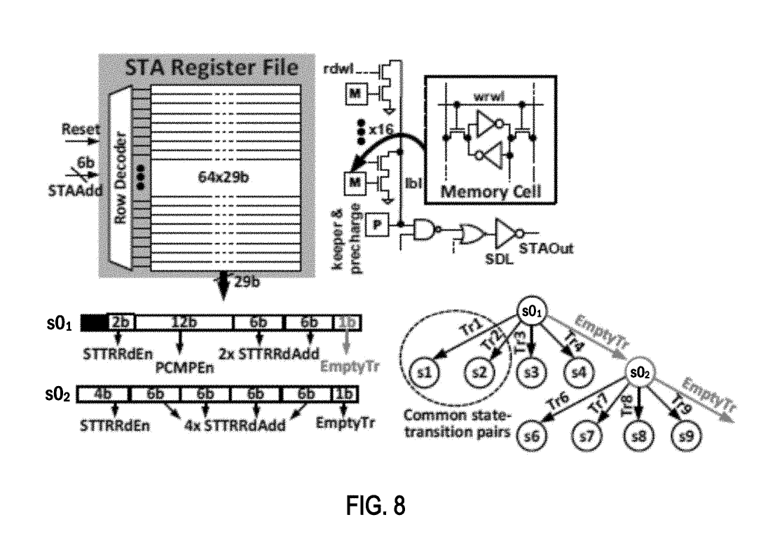

FIG. 8 illustrates an exemplary implementation of the STA according to one embodiment. The exemplary STA comprises sixty-four 29-bit long rows. Each entry in the STA corresponds to a state in the truncated DFA and may span one or more rows depending on the number of transitions out of that state. In a typical STA entry that takes up one row, the 29-bits are split into 12 PCMP enable bits (PCMPEn), two 6-bit STTR read addresses (STTRRdAdd), 2 read-enable bits (STTRrdEn), and one empty transition bit (EmptyTr). Each of the 12 PCMPEn bits corresponds to 1 of the 12 common state-transition pairs stored in the PCMP. An enabled PCMPEn bit indicates that the common state-transition pair corresponding to the PCMPEn bit is valid for the state. The two 6-bit STTR read addresses each stores the address of one unique transition pair. The 2 read-enabled bits correspond to the two 6-bit STTR read addresses and are used to indicate whether the corresponding STTR read address is valid for the state. According to this design, a typical STA entry thus supports up to 12 common transition pairs plus two unique transition pairs. To support DFA states having more state-transition pairs, the concept of empty transition is implemented according to one embodiment. When the empty transition bit is enabled in an STA entry, it means the next entry does not begin a new state but instead contains more transition pairs for the current state. In one embodiment, the empty transition is taken by default if the transitions in the current row do not match. The implementation of empty transition removes the restriction on maximum supported transition per state based on bit-width choice of the STA hardware.

According to the embodiment illustrated in FIG. 8, if the empty transition bit of an STA entry s0₁ is enabled, the next STA entry s0₂ will contain four 6-bit STTR read addresses, four read enable bits, and an empty bit. The four 6-bit STTR read addresses represent four more unique transition pair and the corresponding four read enabled bits indicate whether each of the four STTR read address is valid for the state. The number of transition pairs per STA row is chosen to minimize unused bits in STA across all states. As mentioned above, since the specific size and quantity of STA may vary across implementations, one skilled in the arts would appreciate that different number of STTR read address may be stored per STA row.

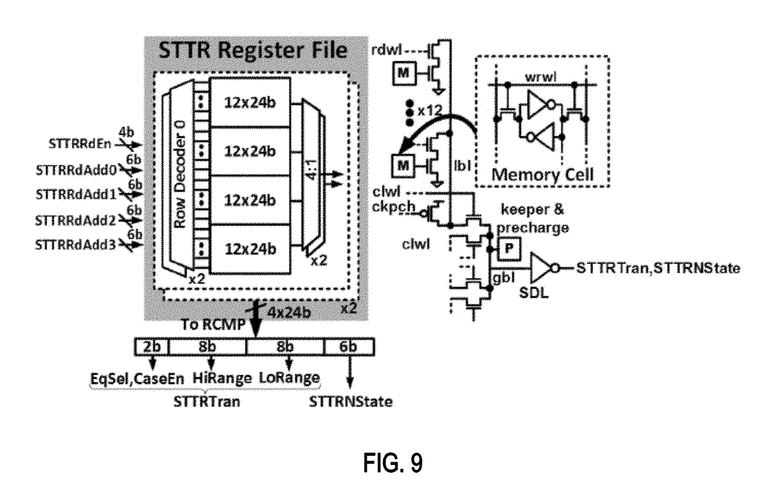

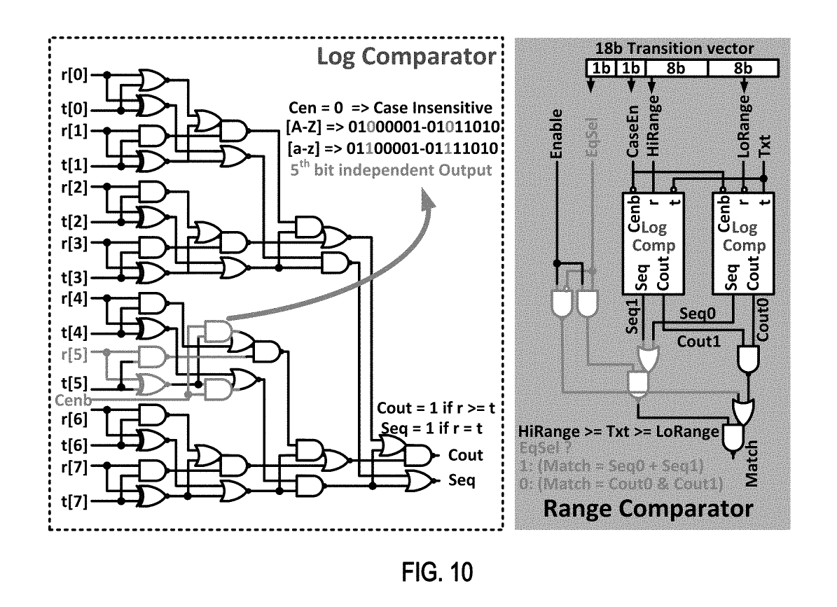

In operation, according to an embodiment, the DFA is traversed by reading a state row from STA which can contain up-to 4 STTR read addresses. Thus, to processes the 4 STTR read addresses simultaneously, the STTR is designed with 4 read ports. As illustrated in FIG. 9, according to one embodiment, the 48 by 24-bit STTR is implemented using a 2R1W memory cell with 4-way banked and 2-way 4:1 Mux to realize 4 simultaneous reads. This results in a 30% area saving. Data stored in STA and STTR can be rearranged architecturally to avoid any conflict across STTR banks during read. The 24-bit state-transition pair entry in the STTR uses 6-bits for next state address and 18-bits for the transition value. 4 state-transition pairs are read from STTR and fed to a transition comparator (TCMP) implemented using 4 range comparators. FIG. 10 shows the circuit implementation of the range comparator according to an embodiment. A 16-bit range comparator is designed to detect transition between two states of a DFA. The transition value of the transition can be a either a single character, a character class, or a range of characters, represented by their corresponding 8-bit ASCII value. In an embodiment, a partial 8-bit log comparator producing only carry out is implemented. According to another embodiment, a case insensitive transition detection is integrated into the comparator by forcing the 5th bit propagate to be “1” and generate to be “0”. This is implemented by writing a “1” at bit 5 of the stored transition value and a case insensitive bit (CaseEn) without increasing the critical path delay. This makes output independent of the 5th bit of input character used to distinguish between upper and lower case character, thus enabling the case insensitive functionality. Furthermore, since using range detection for only a single character transition underutilizes the memory storage, according to another embodiment, the range comparator can be modified to detect two single character transitions by adding an equality path. The addition of the equality path costs only a 10% delay overhead while saves valuable state-transition memory storage and increases throughput.

As mentioned above, in a typical truncated DFA, due to continuous prefix checking, some state-transition pairs are common to many of the states. In one embodiment, a parallel comparator (PCMP) unit comprising 12 parallel range comparators is implemented. Each parallel range comparator contains pre-stored common transitions (character ranges) to compare against the incoming text characters for all the states. In conjunction, the STA stores 12 enable bits per state (PCMPEn) to indicate which of the common state-transition pairs are valid for each given state. The results of 12 parallel comparators are gated with the 12 PCMPEn bits to generate final PCMP match and to determine the corresponding next state STA address. The implementation of PCMP unit reduces the number of STA entries needed for storing whole DFA filter as well as the average number of cycles needed to traverse a state. This optimization results in additional 30% reduction in storage cost and 4× improvement in throughput. All hardware architecture optimizations (isolating unique state-transition pairs, parallel detection of common transitions and empty transitions support) based on key DFA characteristics improve the area-efficiency of the DFA filter by 70%.

In one embodiment, the results from TCMP and PCMP are combined to form a match. Then the state address corresponding to the match is selected as new state address. However, if no match was found by both TCMP and PCMP, the empty transition bit is examined. If the empty transition bit is one, the previous STA address is incremented by one and set as the new state address. If empty transition bit is zero, then the matching process starts over with state zero address set for the next text character. This next character address is stored as initial scan address (character address starting from state zero) for current scan. In this design the leaf nodes of truncated DFA (representing positive) is also stored as address of state zero. Hence if there is a match and next state address is state zero this represents a true/false positive match. For these positive matches the initial scan address for current scan (stored earlier) are recorded which later used/handled by exact match software. The initial scan address enables software to start from state zero at this character address allowing hardware independent exact match software implementation with choice of any optimization algorithm. The whole dataset can either be divided into three sets or 3 independent datasets can run in parallel to fill the pipeline and hide 3 cycle latency.

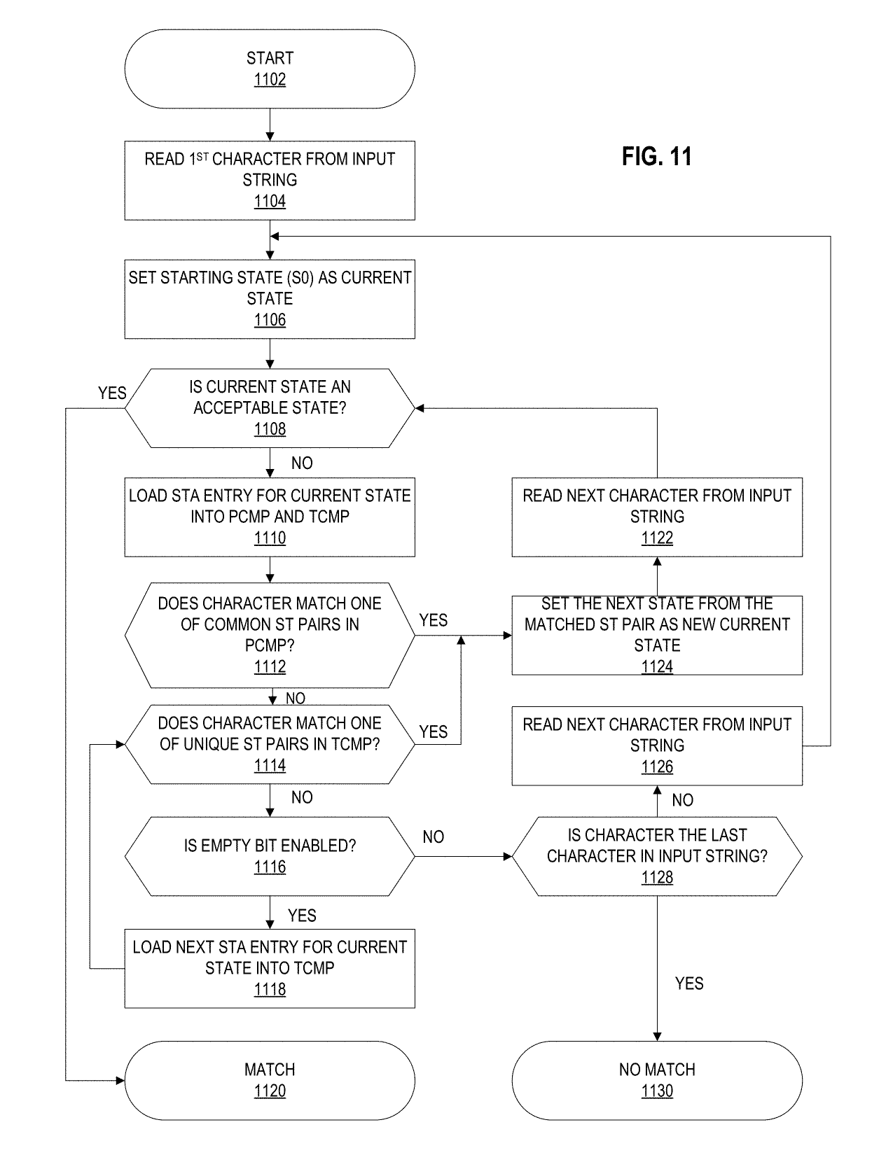

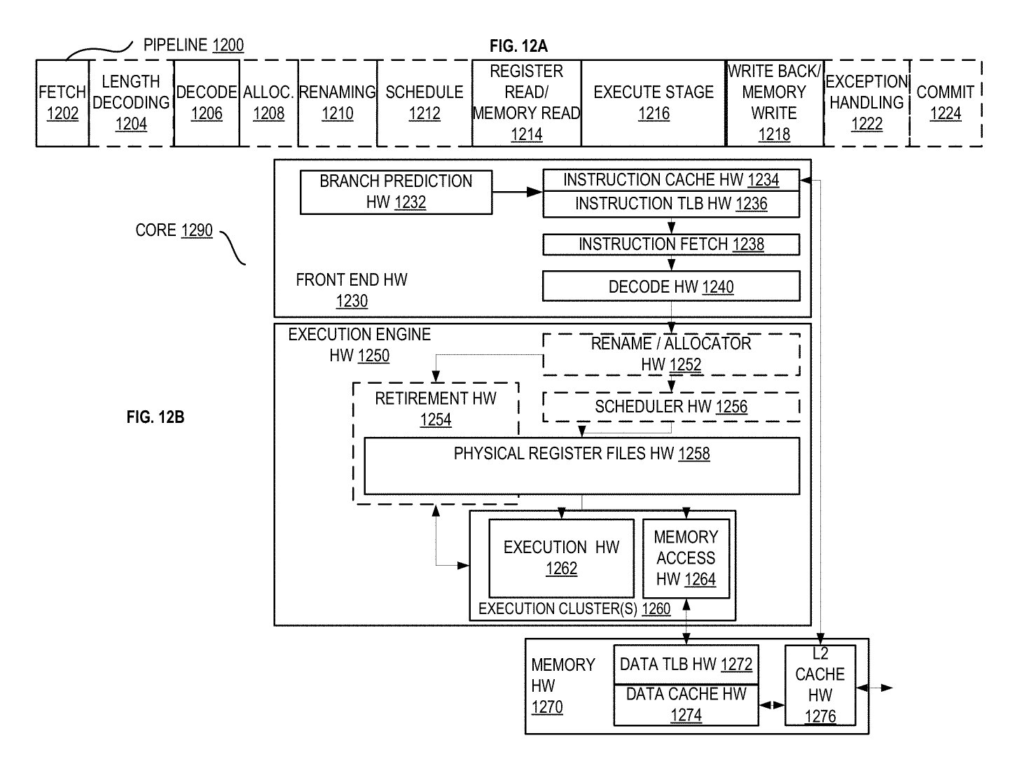

FIG. 11 is a flow diagram illustrating the operation and logic of the partial pattern matcher in accordance to an embodiment. The operation starts at block 1102. In block 1104, partial pattern matcher reads the first character from the input string. Next, since all traversal through a DFA begins with the starting state S0, the current state is set to the starting state in block 1106. In block 1108, the current state is checked to see if it is an acceptable state. A positive determination here would end the pattern-matching task with a successful match in block 1120. However, assuming the current state is not an acceptable state, the STA entry corresponding to the current state is fetched and fed into the parallel comparator (PCMP) and the transition comparator (TCMP) in block 1110. Next, the input character is checked against the 12 common state-transition (ST) pairs in PCMP in block 1112 and against the 2 unique ST pairs in TCMP in block 1114. A successful match from either comparator sets the next state, as indicated by the matched ST pair entry, as the new current state in block 1124. This traverses the DFA for further matching against the next character in the input string. Accordingly, in block 1122, the next character in the input string is read by the partial pattern matcher and the pattern matching starts again at block 1108 with the next character. On the other hand, if no successful match was found in blocks 1112 and 1114, the empty bit in the STA entry is examined in block 1116. If the empty bit is enabled, indicating that there are more unique ST pair for the current state stored in the STA, the next STA entry is loaded into the TCMP in block 1118 accordingly. Thereafter, the character is checked against the new set of unique ST pairs in TCMP in block 1114. This check is repeated until the character matches a unique ST pair in TCMP or until there are no more unique ST pairs left in the current state to check against. This happens when an STA entry with a disabled empty bit is reached, indicating it as the last STA entry associated with the current state. If that is the case and no match was found for the current character, a determination is made in block 1128 on whether the character is the last character in the input string. If so, the pattern matching is complete resulting in a no match as indicated by block 1130. However, if there are more characters left in the string to be checked, the pattern matching starts again beginning with reading in the next character in the input string in block 1126 and resetting the current state to S0 in block 1106.

FIG. 12A is a block diagram illustrating both an exemplary in-order pipeline and an exemplary register renaming, out-of-order issue/execution pipeline according to embodiments of the invention. FIG. 12B is a block diagram illustrating both an exemplary embodiment of an in-order architecture core and an exemplary register renaming, out-of-order issue/execution architecture core to be included in a processor according to embodiments of the invention. The solid lined boxes in FIGS. 12A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12A, a processor pipeline 1200 includes a fetch stage 1202, a length decode stage 1204, a decode stage 1206, an allocation stage 1208, a renaming stage 1210, a scheduling (also known as a dispatch or issue) stage 1212, a register read/memory read stage 1214, an execute stage 1216, a write back/memory write stage 1218, an exception handling stage 1222, and a commit stage 1224.

FIG. 12B shows processor core 1290 including a front end hardware 1230 coupled to an execution engine hardware 1250, and both are coupled to a memory hardware 1270. The core 1290 may be a reduced instruction set computing (RISC) core, a complex instruction set computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front end hardware 1230 includes a branch prediction hardware 1232 coupled to an instruction cache hardware 1234, which is coupled to an instruction translation lookaside buffer (TLB) 1236, which is coupled to an instruction fetch hardware 1238, which is coupled to a decode hardware 1240. The decode hardware 1240 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 1240 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1290 includes a microcode ROM or other medium that stores microcode for certain macroinstructions (e.g., in decode hardware 1240 or otherwise within the front end hardware 1230). The decode hardware 1240 is coupled to a rename/allocator hardware 1252 in the execution engine hardware 1250.

The execution engine hardware 1250 includes the rename/allocator hardware 1252 coupled to a retirement hardware 1254 and a set of one or more scheduler hardware 1256. The scheduler hardware 1256 represents any number of different schedulers, including reservations stations, central instruction window, etc. The scheduler hardware 1256 is coupled to the physical register file(s) hardware 1258. Each of the physical register file(s) hardware 1258 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 1258 comprises a vector registers hardware, a write mask registers hardware, and a scalar registers hardware. These register hardware may provide architectural vector registers, vector mask registers, and general purpose registers. The physical register file(s) hardware 1258 is overlapped by the retirement hardware 1254 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 1254 and the physical register file(s) hardware 1258 are coupled to the execution cluster(s) 1260. The execution cluster(s) 1260 includes a set of one or more execution hardware 1262 and a set of one or more memory access hardware 1264. The execution hardware 1262 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 1256, physical register file(s) hardware 1258, and execution cluster(s) 1260 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 1264). It should also be understood that where separate pipelines are used, one or more of these pipelines may be out-of-order issue/execution and the rest in-order.

The set of memory access hardware 1264 is coupled to the memory hardware 1270, which includes a data TLB hardware 1272 coupled to a data cache hardware 1274 coupled to a level 2 (L2) cache hardware 1276. In one exemplary embodiment, the memory access hardware 1264 may include a load hardware, a store address hardware, and a store data hardware, each of which is coupled to the data TLB hardware 1272 in the memory hardware 1270. The instruction cache hardware 1234 is further coupled to a level 2 (L2) cache hardware 1276 in the memory hardware 1270. The L2 cache hardware 1276 is coupled to one or more other levels of cache and eventually to a main memory.

By way of example, the exemplary register renaming, out-of-order issue/execution core architecture may implement the pipeline 1200 as follows: 1) the instruction fetch 1238 performs the fetch and length decoding stages 1202 and 1204; 2) the decode hardware 1240 performs the decode stage 1206; 3) the rename/allocator hardware 1252 performs the allocation stage 1208 and renaming stage 1210; 4) the scheduler hardware 1256 performs the schedule stage 1212; 5) the physical register file(s) hardware 1258 and the memory hardware 1270 perform the register read/memory read stage 1214; the execution cluster 1260 perform the execute stage 1216; 6) the memory hardware 1270 and the physical register file(s) hardware 1258 perform the write back/memory write stage 1218; 7) various hardware may be involved in the exception handling stage 1222; and 8) the retirement hardware 1254 and the physical register file(s) hardware 1258 perform the commit stage 1224.

The core 1290 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1290 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 1234/1274 and a shared L2 cache hardware 1276, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

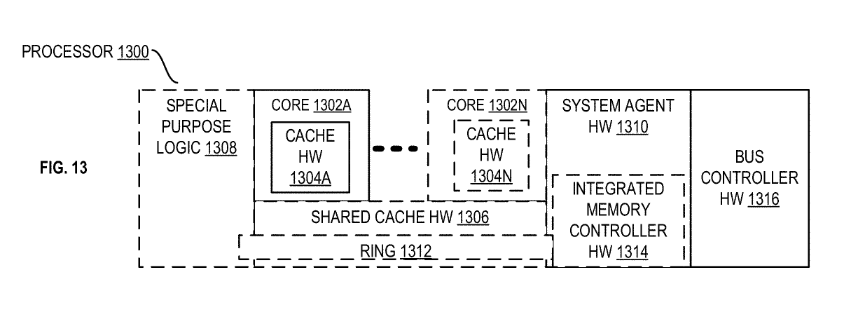

FIG. 13 is a block diagram of a processor 1300 that may have more than one core, may have an integrated memory controller, and may have integrated graphics according to embodiments of the invention. The solid lined boxes in FIG. 13 illustrate a processor 1300 with a single core 1302A, a system agent 1310, a set of one or more bus controller hardware 1316, while the optional addition of the dashed lined boxes illustrates an alternative processor 1300 with multiple cores 1302A-N, a set of one or more integrated memory controller hardware 1314 in the system agent hardware 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 1306, and external memory (not shown) coupled to the set of integrated memory controller hardware 1314. The set of shared cache hardware 1306 may include one or more mid-level caches, such as level 2 (L2), level 3 (L3), level 4 (L4), or other levels of cache, a last level cache (LLC), and/or combinations thereof. While in one embodiment a ring based interconnect hardware 1312 interconnects the integrated graphics logic 1308, the set of shared cache hardware 1306, and the system agent hardware 1310/integrated memory controller hardware 1314, alternative embodiments may use any number of well-known techniques for interconnecting such hardware. In one embodiment, coherency is maintained between one or more cache hardware 1306 and cores 1302-A-N.

In some embodiments, one or more of the cores 1302A-N are capable of multi-threading. The system agent 1310 includes those components coordinating and operating cores 1302A-N. The system agent hardware 1310 may include for example a power control unit (PCU) and a display hardware. The PCU may be or include logic and components needed for regulating the power state of the cores 1302A-N and the integrated graphics logic 1308. The display hardware is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set. In one embodiment, the cores 1302A-N are heterogeneous and include both the “small” cores and “big” cores described below.

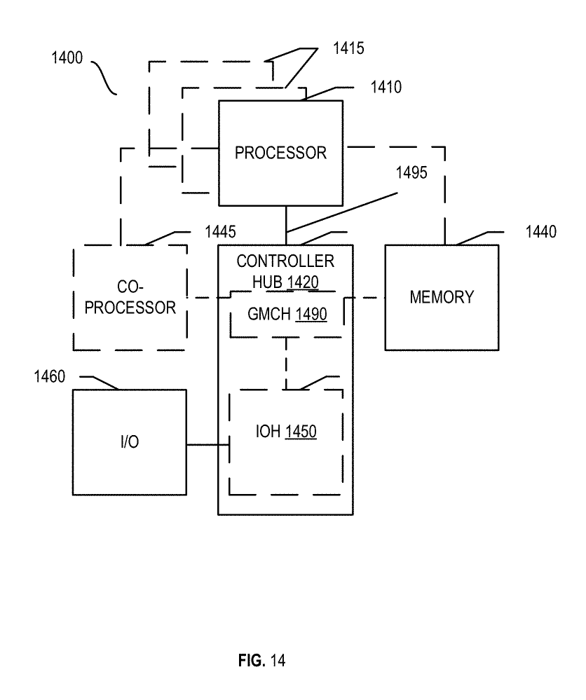

FIGS. 14-17 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 in accordance with one embodiment of the present invention. The system 1400 may include one or more processors 1410, 1415, which are coupled to a controller hub 1420. In one embodiment the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 is couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450.

The optional nature of additional processors 1415 is denoted in FIG. 14 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface, or similar connection 1495.

In one embodiment, the coprocessor 1445 is a special-purpose processor, such as, for example, a high-throughput MIC processor, a network or communication processor, compression engine, graphics processor, GPGPU, embedded processor, or the like. In one embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

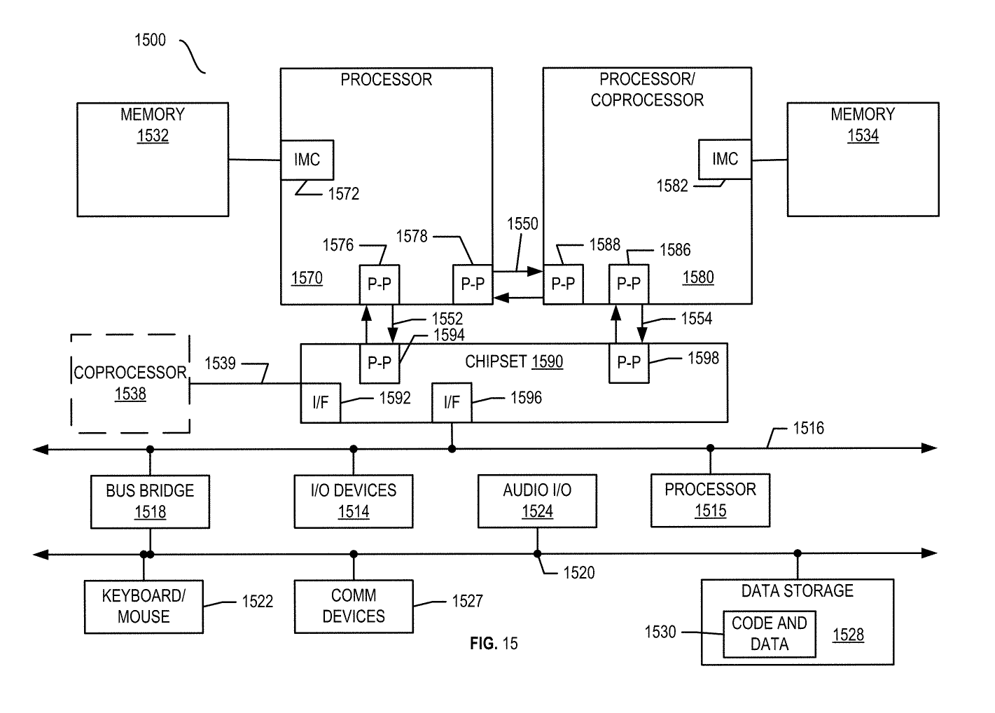

Referring now to FIG. 15, shown is a block diagram of a first more specific exemplary system 1500 in accordance with an embodiment of the present invention. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one embodiment of the invention, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) hardware 1572 and 1582, respectively. Processor 1570 also includes as part of its bus controller hardware point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1539. In one embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 15, various I/O devices 1514 may be coupled to first bus 1516, along with a bus bridge 1518 which couples first bus 1516 to a second bus 1520. In one embodiment, one or more additional processor(s) 1515, such as coprocessors, high-throughput MIC processors, GPGPU's, accelerators (such as, e.g., graphics accelerators or digital signal processing (DSP) hardware), field programmable gate arrays, or any other processor, are coupled to first bus 1516. In one embodiment, second bus 1520 may be a low pin count (LPC) bus. Various devices may be coupled to a second bus 1520 including, for example, a keyboard and/or mouse 1522, communication devices 1527 and a storage hardware 1528 such as a disk drive or other mass storage device which may include instructions/code and data 1530, in one embodiment. Further, an audio I/O 1524 may be coupled to the second bus 1520. Note that other architectures are possible. For example, instead of the point-to-point architecture of FIG. 15, a system may implement a multi-drop bus or other such architecture.

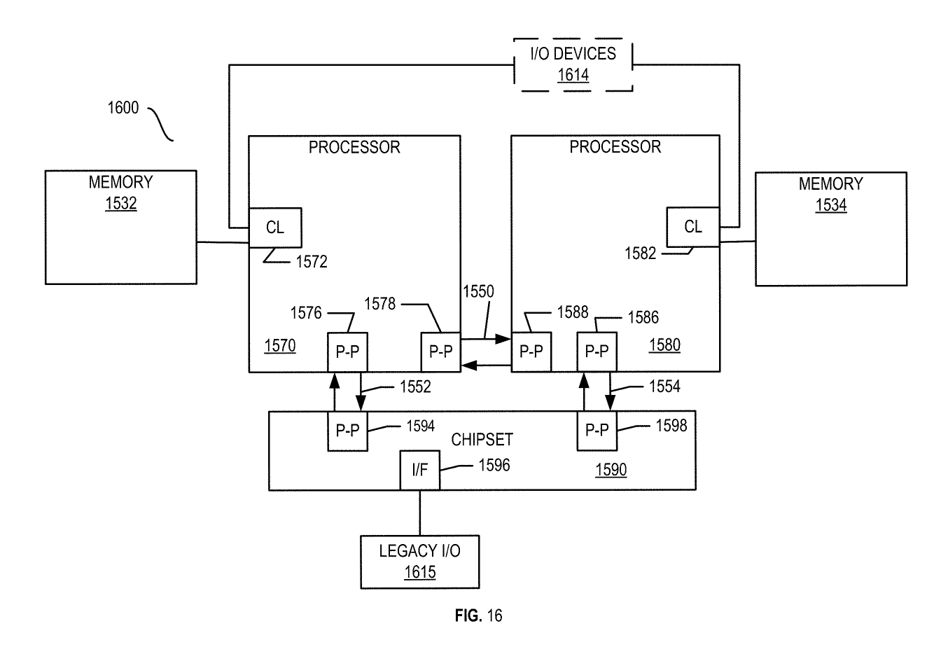

Referring now to FIG. 16, shown is a block diagram of a second more specific exemplary system 1600 in accordance with an embodiment of the present invention. Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processors 1570, 1580 may include integrated memory and I/O control logic (“CL”) 1572 and 1582, respectively. Thus, the CL 1572, 1582 include integrated memory controller hardware and include I/O control logic. FIG. 16 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

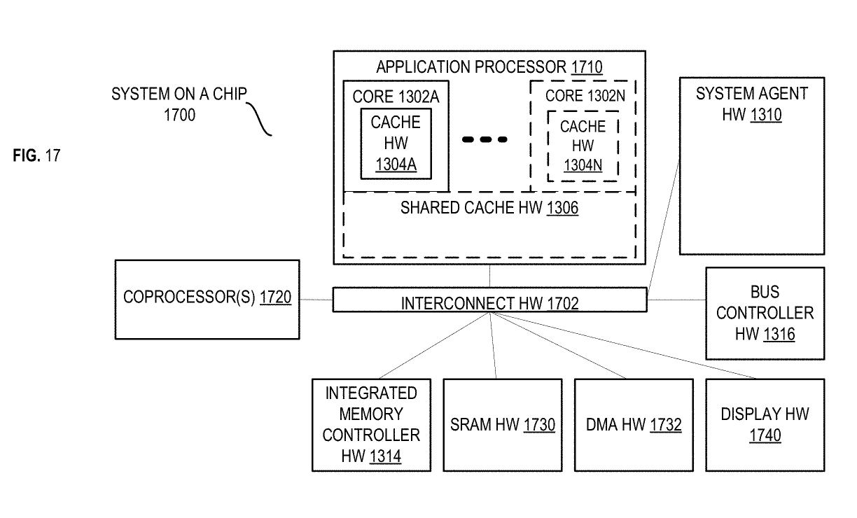

Referring now to FIG. 17, shown is a block diagram of a SoC 1700 in accordance with an embodiment of the present invention. Similar elements in FIG. 13 bear like reference numerals. Also, dashed lined boxes are optional features on more advanced SoCs. In FIG. 17, an interconnect hardware 1702 is coupled to: an application processor 1710 which includes a set of one or more cores 1302A-N and shared cache hardware 1306; a system agent hardware 1310; a bus controller hardware 1316; an integrated memory controller hardware 1314; a set or one or more coprocessors 1720 which may include integrated graphics logic, an image processor, an audio processor, and a video processor; an static random access memory (SRAM) hardware 1730; a direct memory access (DMA) hardware 1732; and a display hardware 1740 for coupling to one or more external displays. In one embodiment, the coprocessor(s) 1720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 15, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

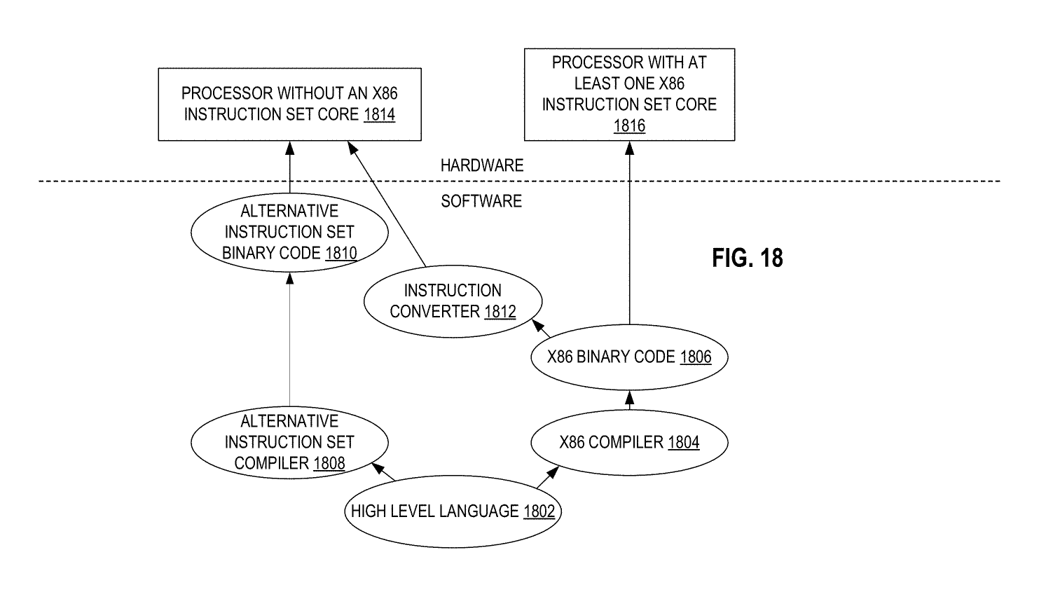

FIG. 18 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816. The processor with at least one x86 instruction set core 1816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 18 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation or any other process, allows a processor or other electronic device that does not have an x86 instruction set processor or core to execute the x86 binary code 1806.

1. An apparatus comprising:
a string convertor circuit to represent a set of reference strings as a deterministic finite automaton (DFA);
a DFA truncator circuit to truncate the DFA based on a truncating policy, wherein the truncated DFA does not generate a false positive match;
a filter circuit, based on the truncated DFA, to filter an input string against the set of reference strings.

2. The apparatus of claim 1, wherein the truncating policy comprises truncating the DFA at a fixed depth.

3. The apparatus of claim 1, wherein the truncating policy comprises truncating the DFA based on a selected probability of reaching a certain state in the DFA.

4. The apparatus of claim 1, wherein the filter circuit comprises a memory to store one or more state-transition pairs of the truncated DFA.

5. The apparatus of claim 4, wherein the one or more state-transition pairs of the truncated DFA comprise every unique state-transition pairs in the truncated DFA.

6. The apparatus of claim 4, wherein the one or more state-transition pairs of the truncated DFA comprise one or more frequently-matched unique state-transition pairs in the truncated DFA.

7. The apparatus of claim 4, wherein the filter circuit comprises one or more range comparator circuits to detect whether a given character from the input string is within a range of characters specified by one of the one or more state-transition pairs in the truncated DFA.

8. The apparatus of claim 7, wherein the detection of whether a given character from the input string is within a range of characters specified by one of the one or more state-transition pairs in the truncated DFA is made irrespective of whether the given character is of uppercase or lowercase representation.

9. A method comprising:
representing a set of reference strings as a deterministic finite automaton (DFA);
truncating the DFA such that the truncated DFA does not generate a false positive match;
filtering an input string against the set of reference strings using a filter based on the truncated DFA.

10. The method of claim 9, wherein truncating the DFA comprises truncating the DFA at a fixed depth.

11. The method of claim 9, wherein truncating the DFA comprises truncating the DFA based on a selected probability of reaching a certain state in the DFA.

12. The method of claim 9, wherein filtering the input string against the set of reference strings comprises:
identifying one or more state-transition pairs in the truncated DFA;
storing the identified one or more state-transition pairs in a memory;
detecting whether a given character from the input string is within a range of characters specified by one of the one or more identified state-transition pairs in the truncated DFA.

13. The method of claim 12, wherein the one or more identified state-transition pairs comprise every unique state-transition pairs in the truncated DFA.

14. The method of claim 12, wherein the one or more identified state-transition pairs comprise one or more frequently-matched unique state-transition pairs in the truncated DFA.

15. The method of claim 12, wherein the detection of whether a given character from the input string is within a range of characters specified by one of the one or more identified state-transition pairs in the truncated DFA is made irrespective of whether the given character is of uppercase or lowercase representation.
